(19) United States
(12) Patent Application Publication
(10) Pub. No.: US 2018/0113100 A1
(43) Pub. Date: Apr. 26, 2018

(54) PHASED ARRAY WELD INSPECTION SYSTEM WITH ASSISTED ANALYSIS TOOLS

(71) Applicants: Martin St-Laurent, Quebec (CA); Jason Habermehl, Quebec (CA); Pierre Langlois, Quebec (CA); Benoit Lepage, Quebec (CA)

(72) Inventors: Martin St-Laurent, Quebec (CA); Jason Habermehl, Quebec (CA); Pierre Langlois, Quebec (CA); Benoit Lepage, Quebec (CA)

(73) Assignee: Olympus Scientific Solutions Americas Inc., Waltham, MA (US)

(21) Appl. No.: 15/333,367

(22) Filed: Oct. 25, 2016

(51) Int. Cl. G01N 29/44; G01N 29/04; G01N 29/26; G01B 17/06

(52) U.S. Cl. CPC G01N 29/4445; G01N 29/04; G01N 29/26; G01N 2291/0289; G01N 2291/267; G01N 2291/044; G01B 17/06

(57) ABSTRACT

Disclosed is an assisted analysis unit for facilitating phased array defect inspection. The analysis unit comprises an identification & merging module, and a sizing module. The modules are capable of displaying defect contours from multiple groups of indications, and of recommending defect merging candidates and defect sizing methods. However both modules also accept user input so that the final decisions rest with the operator.

### FIELD OF THE INVENTION

The invention relates to non-destructive test and inspection (NDT/NDI), in particular to the inspection of welds using phased array ultrasound technology (PAUT) with improvements made to assist a user in analyzing PAUT raw data acquired during a weld inspection.

### BACKGROUND OF THE INVENTION

PAUT systems are often used for inspection of industrial components, and generally comprise one or more probes to transmit the ultrasonic beam and receive echo responses, an acquisition unit to receive the data, a data processing unit to interpret the data it receives, and a display module that presents the data to the inspector.

According to NDT codes and standards, indications of possible defects or flaws must be processed by an NDT certified human inspector. In order to verify the presence of any defects and to characterize their size and defect type, the inspector must spend a large amount of time analyzing the raw data. In general, the raw data may be received in various forms, such as A-scans or B-scans, and may be derived from different probes or from different scan modes with the same probe. The inspector has to sort through all this information in order to determine the integrity of an examined volume within the component. The examined volume may contain several indications, some of which may in fact be different indications from the same flaw. The inspector must decide which of the indications should be merged into a single flaw, and, finally, the inspector must make a number of judgements on whether or not the size and/or nature of the detected flaws make the part unacceptable for reasons of safety or reliability.

A problem with the current method is that it takes too long, and is quite tedious due to all the analysis that must be performed manually by the inspector. A further problem with the current method is that the inspector must manually identify all the raw data associated with the volume under inspection. A further problem is that no assistance is available to help the operator identify which indications may be candidates for merging based on known merging rules, or to correctly size indications based on known sizing rules.

Inspecting materials for defects is an important task, which must be done by qualified human inspectors. Such inspectors must have the knowledge, capabilities, and experience necessary to inspect and examine components. In general, safety measures are incorporated into the criteria used for inspections by the inspector, in order to account for assumptions that may have been made by the inspector. For this reason, inspections are often very conservative, with a focus on safety. Therefore, any method of facilitating the inspection process must be reliable, while also allowing the inspector to work manually and to accept of reject any recommendations made by an automatic system.

The idea of facilitating ultrasonic inspection and displaying it in a unique way has been referred to in U.S. Pat. No. 9,177,371, however no actual method is proposed or implemented. Though interacting with the data is mentioned, no details are disclosed as to any method for doing so. The '371 patent also does not disclose anything regarding the merging of multiple detected flaws during the inspection, which is an important part of the inspection process that is currently performed entirely manually.

It would therefore be valuable to have an ultrasonic inspection system which can automatically display raw data associated with the volume under inspection and can assist the operator with merging and sizing of indications, thereby facilitating the inspection and shortening the time taken to perform the inspection. The system should also appropriately prompt the operator to accept or reject its automatic recommendations, so that the ultimate authority lies with the operator.

### SUMMARY OF THE INVENTION

An objective of the present invention is to facilitate and automate those steps in the inspection process that an inspector is not required to do manually, thereby making the inspector's judgement task simpler and more convenient. This objective is achieved through the addition of an assisted analysis unit, which receives volumetric data from a contour generation module. The assisted analysis unit displays contour plots of detected indications, allows the inspector to choose a particular contour for analysis, and then facilitates display of all raw data associated with that contour.

The assisted analysis unit is added to an existing data processor, and further comprises an identification & merging module and a sizing module, both of which are capable of receiving user input. The identification & merging module proposes candidates for merging with the selected contour and may propose a defect type for the selected contour. The sizing module proposes sizing methods to determine the size of the selected flaw.

### BRIEF DESCRIPTIONS OF THE DRAWINGS

FIG. 1 is a schematic diagram showing a phased array inspection system according to the present disclosure.

FIG. 2 is a flowchart showing steps implemented by the identification & merging module according to the present disclosure.

FIGS. 3A, 3B, 3C and 3D are diagrams showing the various functions and capabilities of the identification & merging module.

FIGS. 4A and 4B are diagrams of an object being inspected, illustrating the function of the sizing module according to the present disclosure.

FIG. 5 is a flowchart of steps implemented by the sizing module according to the present disclosure.

### DETAILED DESCRIPTION OF THE INVENTION

The presently disclosed invention relates to ultrasonic inspection of materials, in particular using phased array probes. It should be noted that operation of the inspection system still requires input from a qualified inspector for the purpose of making judgements as to the determination of a defect. One of the key differences between current practice and the present disclosure is that according to the present disclosure multiple steps in processing the received data are performed automatically, rather than requiring the inspector to perform such steps manually. Furthermore, the inspector may interact with, select, and differentiate between different indications, and merge multiple indications into one if necessary.

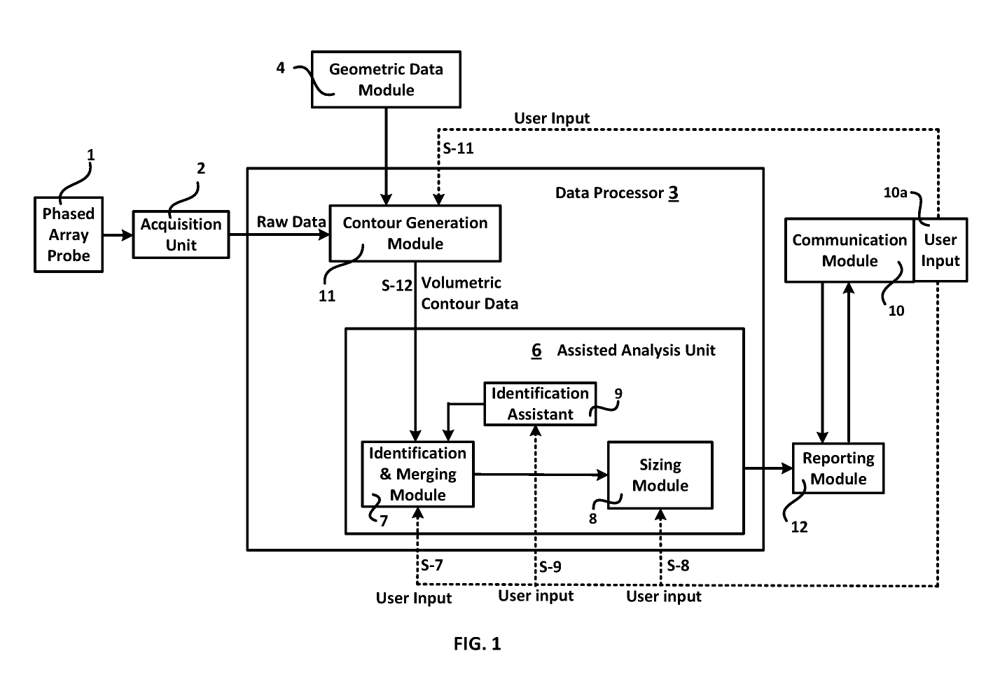

Referring to FIG. 1, a schematic diagram of a preferred embodiment of a phased array inspection system is shown. The phased array inspection system comprises a phased array probe 1, an acquisition unit 2, a data processor 3, a geometric data module 4, a communication module 10, and a reporting module 12. Acquisition unit 2 receives ultrasonic echo data from phased array probe 1, and transmits digitized data to data processor 3. Data processor 3 further comprises a contour generation module 11 and an assisted analysis unit 6. Assisted analysis unit 6 further comprises an identification & merging module 7, a sizing module 8, and an optional identification assistant 9. Contour generation module 11 receives information from geometric data module 4, and also has the option of receiving user input via a user input signal S-11.

It should be noted that the separation of contour generation module 11, identification module 7, and sizing module 8 is herein presented according to the preferred embodiment. It should be appreciated that alternatively designed functional modules performing functions effectively equivalent to those of modules 11, 7 and 8 are within the scope of the present invention.

Data stored within geometric data module 4 may include the shape of the part, its thickness, or the weld description, as well as any other relevant geometric data. Using the geometric data from geometric data module 4, as well as optional user input S-11, contour generation module 11 generates volumetric contour data S-12, which is sent to assisted analysis unit 6. Volumetric contour data S-12 comprises contours of echo responses from flaws detected within the volume of the part being inspected, as well as three dimensional location information of each contour within the inspected volume. The contour generation may be based on amplitude thresholds of the echo responses, but may also include more advanced signal processing features such as contour methods capable of contouring porosity type defects and of filtering out irrelevant geometry echoes. Therefore, the types of contours generated by contour generation module 11 may include intensity contours based on the magnitude of the echo responses, or contours based on other defect features such as shape, spatial configuration or nature of defect clusters.

Assisted analysis unit 6, receives volumetric contour data S-12 necessary to operate identification & merging module 7 and sizing module 8. The user is prompted to interface with identification & merging module 7 via user input S-7. The user may then identify flaws and decide whether or not to merge them. The resulting data is sent to sizing module 8, which determines different methods by which the flaws may be sized, and proposes a recommended sizing method to the inspector, who may accept the recommendation or select an alternative sizing method via a user input S-8. Sizing module 8 then uses the selected sizing method to calculate the size of the flaws.

Optional identification assistant 9 is configured to identify the type of a user selected flaw and to propose an automatic flaw identification to the user. The automatic flaw identification may be based on machine learning techniques, the shape, size or location of the associated contour, or any other automatic identification technique. The user may accept the automatic flaw identification or select an alternative flaw identification via a user input S-9. The selected flaw identification is then passed to identification & merging module 7.

It should be noted that all interactions between the inspector and the various modules of data processor 3 is done through communication module 10, which includes a user input module 10a.

In an alternative embodiment, phased array probe 1 may comprise two or more probes, and acquisition unit 2 may receive data from two or more probes.

A novel aspect of the present disclosure is that it includes identification & merging module 7 and sizing module 8 which collectively are configured to allow:
a. Selection by the operator of one or more contours of interest.
b. Quick access to the relevant PAUT raw data and images associated with the selected contours. For example, there is automatic access to the images and A-scan data for all probes and all inspection modes associated with the volumetric location of the selected contours. This enables the operator to easily navigate the 3D data, so that all data for a particular indication may be examined, comparing data from different probes and/or different inspection modes or beam paths from the same probe.
c. Selection and merging of contours according to a rule selected by the operator.
d. Determination of the defect type corresponding to a selected contour. The determination may be made solely by operator input, or by operator confirmation of a defect type proposed by the system.
e. Automated sizing of defects based on a sizing method chosen by the operator.

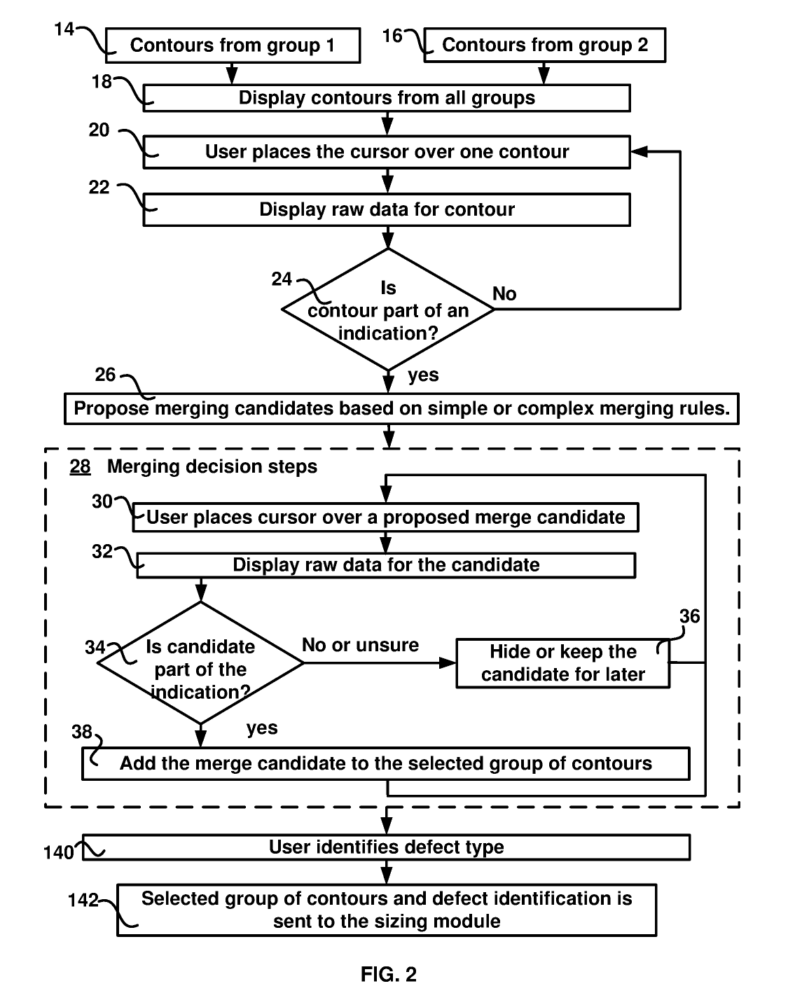

Referring now to FIG. 2, a flowchart shows that identification & merging module 7 is preferably configured to perform a series of steps as illustrated. In step 14, contours from a first inspection scan are detected and placed in group 1, and in step 16 contours from a second inspection scan are detected and grouped together in group 2. Note that the different groups may comprise scans from different probes, and/or different inspection modes of the same probe. For example, group 1 may contain data acquired from a first probe and group 2 may contain data acquired from a second probe. Alternatively, group 1 may contain data from a first inspection mode, and group 2 may contain data from a second inspection mode of the same probe. Contours from both group 1 and group 2 are displayed together in step 18. It should be noted that FIG. 2 illustrates two groups of contours only by way of an exemplary embodiment. Contours may be detected from any number of groups. In step 18 contours may be displayed from all detected groups, and all such embodiments are within the scope of the present invention.

In step 20, the inspector uses a cursor to select one contour. In step 22 identification & merging module 7 displays the raw data associated with the volumetric location of the selected contour. The raw data may comprise images and A-scan data from both group 1 and group 2. By observing the raw data the user is able to decide in step 24 whether or not the selected contour is part of an indication. If it is not part of an indication, but is merely a geometric echo or a response from the weld geometry, the process returns to step 20 and the user is prompted to select another contour. If the selected contour is part of an indication, in step 26 identification & merging module 7 proposes one or more neighboring contours as candidates for merging with the selected contour.

Note that the merging candidates may be selected based on simple or complex merging rules. An example of a simple merging rule is a rule based solely on the distance in three dimensions between the selected contour and a merging candidate. An example of a complex merging rule is a rule where the merging criterion is different in the long dimension of the weld from the other dimensions. Another example of a complex merging rule is a rule where the merging criterion depends on the length of the indication in a particular dimension, such as the long dimension of the weld.

Once identification & merging module 7 has proposed merging candidates in step 26, the process enters a series of merging decision steps 28 represented by a broken line rectangle in FIG. 2. In step 30, the user places a cursor over a first proposed merge candidate, and in step 32 identification & merging module 7 displays the raw data associated with the volumetric location of the selected merge candidate. In step 34 the user decides, based on the raw data, whether or not the merge candidate is part of the indication which was selected in step 20. If not, or if the user is unsure, the merge candidate is hidden from the display but is kept available as a merge candidate for other selected contours, or if the user later wishes approve the candidate to be merged with the present indication. At this point the process returns to step 30 for the user to select a second or subsequent merge candidate. If in step 34 the user decides that the candidate is part of the selected indication, then the candidate is merged into the selected contour or group of contours, and the process returns to step 30 for the user to select a second or subsequent merge candidate.

Once all proposed merging candidates from step 26 have been analyzed, the process exits from merging decision steps 28. In step 140, the user identifies the type of the defect. Alternatively in step 140 identification assistant 9 may suggest a defect type to the user based on the size, shape and location of the indication, and the user may either accept the suggestion or select a different defect type. Finally, in step 142 the volumetric contour data of the selected group of contours and the defect identification are sent to the sizing module to determine the size of the defect.

If there are other contours of interest from the group 1 and group 2 contours, the user may return to step 20 and repeat the process for a newly selected contour.

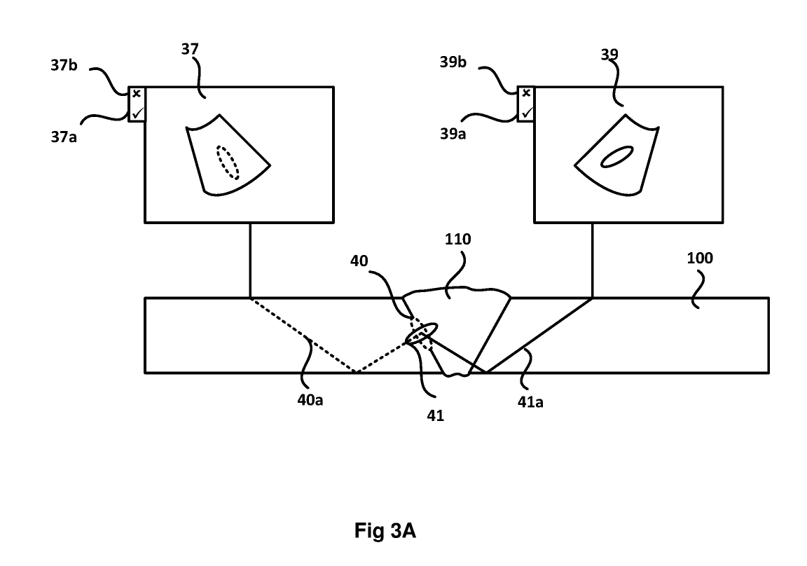

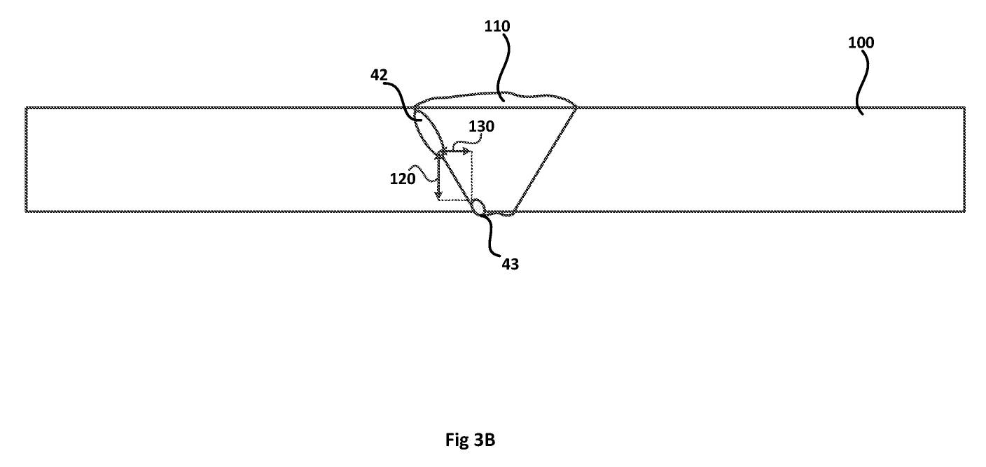

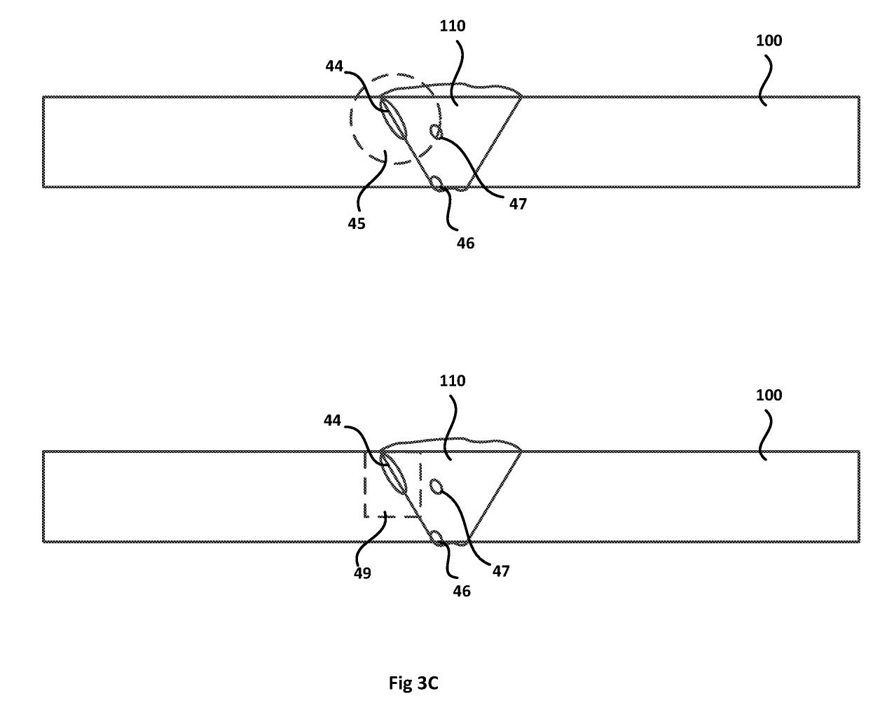

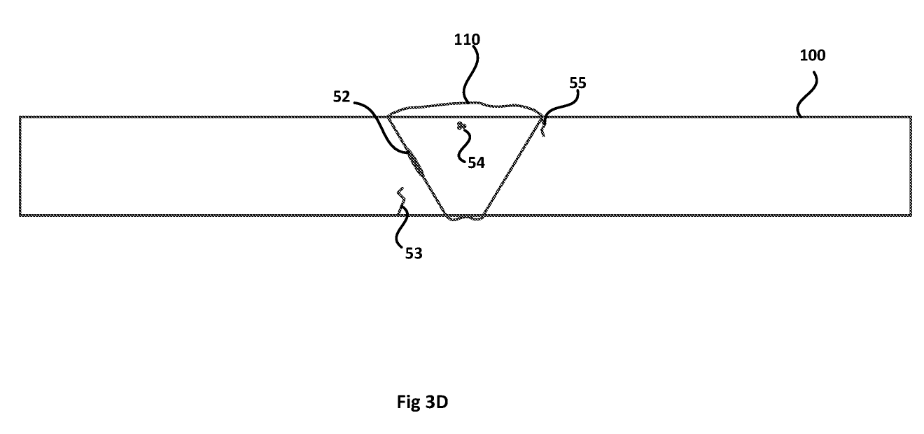

Referring now to FIGS. 3A, 3B, 3C and 3D, the operation of identification & merging module 7 when identifying defects in a weld 110 within a part 100 is illustrated. FIG. 3A shows how identification & merging module 7 displays contours from multiple groups together. A defect contour 40 is detected with a corresponding maximum beam path 40a, and a contour 41 is detected with a corresponding maximum beam path 41a. Detected contours 40 and 41 are shown as displays 37 and 39 respectively, displays 37 and 39 being in the form of S-scans (as shown) or other data (not shown). Note that displays 37 and 39 may be shown on a screen either consecutively or simultaneously. The inspector may confirm the selection of each contour by means of selections 37a and 39a respectively, symbolized by the icons “✓”. Alternatively, if the inspector judges that a contour is not part of the indication to be added, the contour may be removed from the current indication by means of selections 37b and 39b respectively, symbolized by the icons “x”.

FIG. 3B illustrates the way in which the distance between different indications is measured and displayed by identification & merging module 7. Detected indications correspond to a first weld defect 42 and a second weld defect 43. Identification & merging module 7 displays both the horizontal distance 130 and the vertical distance 120 between weld defects 42 and 43.

FIG. 3C depicts how merging of indications may be done according to simple or complex requirements, and how doing so may affect the results. A simple requirement will generally relate only to the geometric distance between contours, whereas a more complex requirement may include one or more additional conditional features. As shown in the upper diagram, defects 44, 46, and 47 are detected in weld 110. A simple merging rule may be schematically represented by a circle 45 centered on defect 44, and also enclosing contour 47, making contours 45 and 47 candidates for merging. In the lower diagram, the same defects 44, 46, and 47 are addressed with a complex merging rule, schematically represented by a rectangle 49 which encloses only defect 44. Note that depiction of a complex merging rule with rectangle 49 is only for schematic illustrative purposes. Under the depicted complex merging rule, neither defect 46 nor defect 47 is considered a candidate for merger with defect 44. A complex rule may require additional information, and is generally not as inclusive as a simpler rule.

Referring to FIG. 3D, five different types of weld flaws that may be detected are illustrated, namely a porosity defect 54, a toe crack 55, a lack of fusion defect 52, and a heat affected zone (HAZ) crack 53. The user is tasked with identifying the defect type, corresponding to step 32 as shown in FIG. 2. Alternatively identification assistant 9 may suggest a defect type to the user based on the size, shape and location of the indication, and the user may either accept the suggestion or select a different defect type.

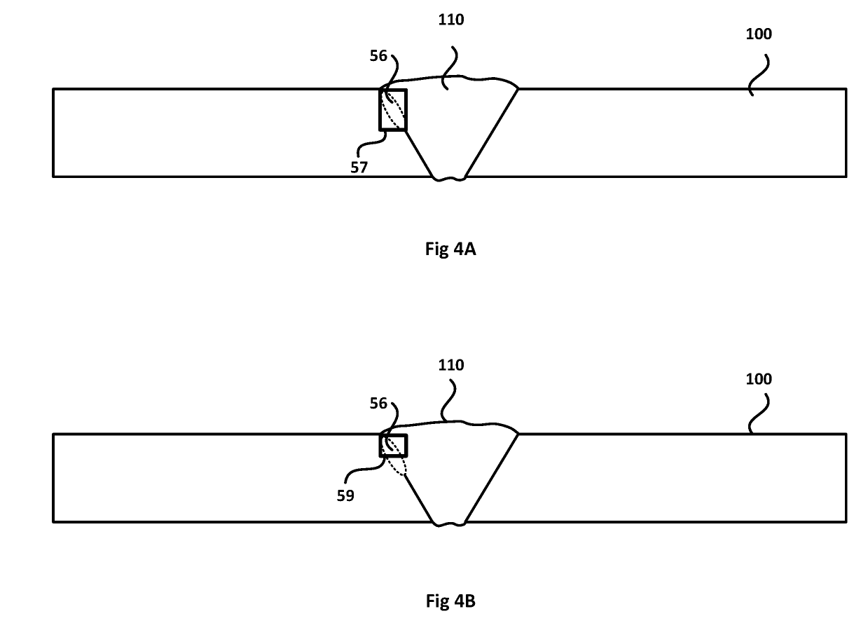

Referring to FIGS. 4A and 4B, the sizing of a flaw based on two different sizing rules is illustrated. As shown, the difference in the sizing rule can affect the display and how the contour is viewed. One example of a sizing rule is a rule based solely on the intensity contour, for example sizing based on the contour at −6 dB below the peak intensity. Another example of a sizing rule is using tip diffraction based sizing. In FIG. 4A a first exemplary sizing rule, represented schematically by a rectangle 57, covers the entirety of a contour 56. On the other hand, in FIG. 4B a second exemplary sizing rule, represented schematically by a rectangle 58, only encloses part of contour 56, showing how a different sizing method may have a different result for the same contour. It should be noted that some sizing methods may require additional information, which should be provided by the inspector as necessary.

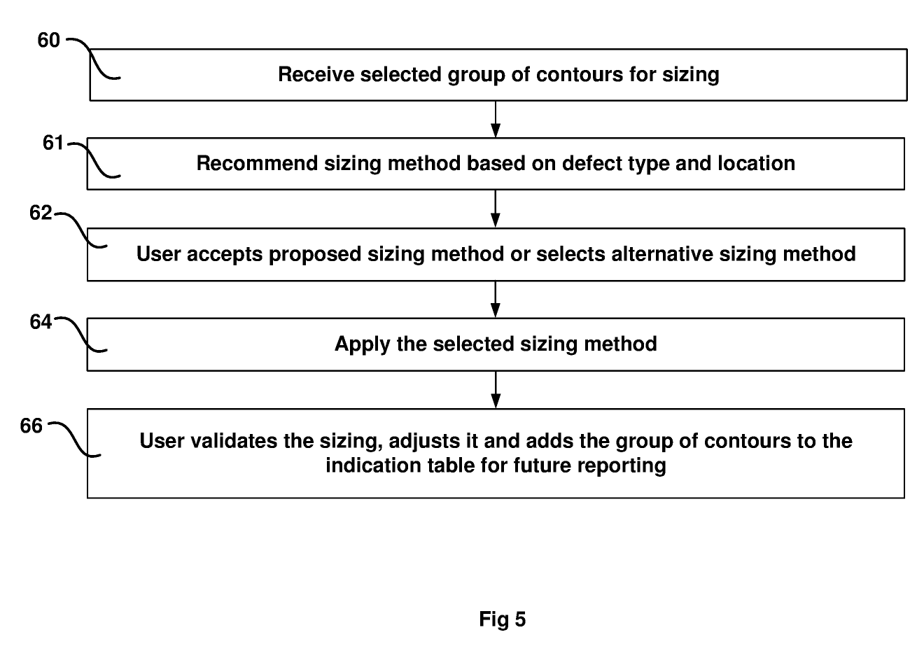

FIG. 5 is a flow chart showing process steps incorporated in sizing module 8. The process begins with step 60, in which sizing module 8 receives the selected contours and defect types from identification & merging module 7. The defect types corresponding to the selected contours have already been identified and neighboring contours have been merged as required. In step 61, sizing module 8 recommends a sizing method for each selected contour, the recommendation being based on the corresponding defect type and its location relative to geometric information from geometric data module 4. In step 62, the inspector may decide to accept the proposed sizing method, or manually select an alternative sizing method, and in step 64 the selected sizing method is applied. Subsequently, in step 66 the inspector must validate the sizing, make adjustments, and then add the group to the indication table for reporting. The various different sizing methods are proposed to the inspector by sizing module 8 based on the available data, but the decision whether to use the proposed method or manually select a different one is left to the inspector's discretion. It is important to note that the sizing module requires the identified contours provided by identification & merging module 7, and therefore cannot operate without first completing the processes of identification & merging module 7.

An important aspect of the present invention is that selected displays and automatic methods are available to assist the inspector, while at the same time the inspector is able to make selections, and to provide input accepting or rejecting system recommendations. The resulting product has an advantage in convenience and speed, with no loss of precision or safety.

It should be noted that the improvements of the present invention are particularly applicable to full matrix capture/total focusing method (FMC/TFM) inspections.

Although the present invention has been described in relation to particular embodiments thereof, it can be appreciated that various designs can be conceived based on the teachings of the present disclosure, and all are within the scope of the present disclosure.

What is claimed is:

1. An ultrasonic inspection system for inspecting a weld in a test object, the inspection system comprising:
at least one phased array probe performing at least one scan of the test object, transmitting ultrasonic energy into the test object and receiving echo responses from flaws in the test object;
an acquisition unit configured to acquire scan data of the echo responses from the at least one scan of the at least one probe;
a geometric data module containing geometric information of the weld and the test object;
a contour generation module configured to receive the scan data and the geometric information, and to produce volumetric contour data comprising a plurality of contours and volumetric coordinates of the echo responses from each of the flaws detected by each of the at least one probe in each of the at least one scan;
an assisted analysis unit configured to assist a user in analyzing a user selected contour from the plurality of contours, the assisted analysis unit comprising:
an identification and merging module configured to identify a flaw type for the user selected contour, to present the corresponding volumetric contour data to the user and to propose to the user merging candidates to be merged into the user selected contour to form a merged contour; and,
a sizing module configured to present a proposed sizing calculator to the user based on the flaw type and the merged contour.

2. The inspection system of claim 1 wherein the plurality of contours are intensity contours, and wherein the intensity contours are based on amplitudes of the echo responses.

3. The inspection system of claim 1 wherein the merging candidates include at least one neighboring contour which is proposed to be merged into the user selected contour to form the merged contour.

4. The inspection system of claim 1 wherein the proposed sizing calculator is determined according to the flaw type and the volumetric coordinates of the merged contour relative to the geometric information.

5. The inspection system of claim 1 wherein the identification and merging module is further configured to receive a first user input in which the user may accept or reject the merging candidates, and wherein the sizing module is further configured to receive a second user input in which the user may accept or reject the proposed sizing calculator.

6. The inspection system of claim 1 wherein the identification and merging module is further configured to display selected scan data generated from each of the at least one probe and each of the at least one scan, the selected scan data corresponding to the user selected contour.

7. The inspection system of claim 1 wherein the at least one phased array probe is two phased array probes located on a surface of the test object on either side of the weld, and the at least one scan is a mechanical scan of each of the two phased array probes wherein each of the probes is moved along a path which is substantially parallel to a center line of the weld.

8. The inspection system of claim 7 wherein each of the two phased array probes transmits ultrasonic energy into the test object in the form of a sectorial phased array scan.

9. The inspection system of claim 1 wherein the identification and merging module is further configured to propose merging candidates based on simple or complex merging rules.

10. The inspection system of claim 1 wherein the identification and merging module is further configured to receive input from the user to identify the flaw type.

11. The inspection system of claim 5 wherein the assisted analysis unit further comprises an identification assistant for determining a proposed flaw type for the user selected contour, the proposed flaw type being based on the volumetric contour data and the geometric information, and wherein the identification assistant is configured to receive a third user input in which the user may accept or reject the proposed flaw type.

12. The inspection system of claim 11 wherein the first, second and third user inputs are in the form of a check box for accepting or rejecting a respective module proposal.

13. The inspection system of claim 11 further comprising a communication module for displaying data to the user and for receiving the first, second and third user inputs.

14. The inspection system of claim 5 wherein the sizing module is further configured to allow the user to select an alternative sizing calculator in the event that the user rejects the proposed sizing calculator.

15. The inspection system of claim 14 wherein the sizing module is further configured to calculate a flaw size for each flaw using either the proposed sizing calculator or the alternative sizing calculator.

16. The inspection system of claim 15 further comprising a reporting module for reporting a result of an inspection, the result including an indication table comprising a list of the flaws, the flaw type for each flaw and the flaw size for each flaw.

17. A method of assisting a user to identify a selected flaw in a weld in a test object, and to form a merged flaw by merging one or more neighboring flaws into the selected flaw, the method comprising the steps of:
detecting ultrasonic echo responses from at least one phased array probe performing at least one scan of the test object;
receiving geometric data comprising geometric information of the weld and the test object;
displaying volumetric contour data comprising contours and volumetric coordinates of the echo responses from flaws detected by each of the at least one phased array probe in each of the at least one scan;
receiving input from the user of a user selected contour corresponding to the selected flaw;
proposing merging candidates to the user;
receiving an input from the user accepting or rejecting each of the merging candidates; and,
identifying a flaw type for the merged flaw.

18. The method of claim 17, wherein the merging candidates are contours of at least one of the one or more neighboring flaws which are proposed to be merged into the user selected contour to form a merged contour of a single merged flaw.

19. The method of claim 17 wherein the contours are intensity contours, and wherein the intensity contours are based on amplitudes of the echo responses.

20. The method of claim 17 wherein the step of proposing merging candidates further includes a step of selecting merging candidates based on simple or complex merging rules.

21. The method of claim 17 wherein the step of identifying the flaw type further includes a step of receiving input from the user to identify the flaw type.

22. The method of claim 17 wherein the step of identifying the flaw type further includes the steps of:
identifying a proposed flaw type for the merged flaw, the proposed flaw type being based on the volumetric contour data and the geometric information; and,
receiving input from the user in which the user may accept or reject the proposed flaw type.

23. A method of assisting a user to size a selected flaw in a weld in a test object, the method comprising the steps of:
detecting ultrasonic echo responses from at least one phased array probe performing at least one scan of the test object;
receiving volumetric contour data comprising contours and volumetric coordinates of the echo responses from flaws detected by each of the at least one phased array probe in each of the at least one scan;
receiving geometric data comprising geometric information of the weld and the test object;
receiving identification data, wherein the identification data comprises a flaw type for each one of the flaws;
proposing a recommended sizing calculator and at least one alternative sizing calculator for sizing the selected flaw;
receiving input from the user of a user selected sizing calculator, the user selected sizing calculator being a selected one of the recommended sizing calculator or the at least one alternative sizing calculator; and,
calculating a flaw size based on the user selected sizing calculator.

24. The method of claim 23 wherein the recommended sizing calculator and the at least one alternative sizing calculator are based on the flaw type and the volumetric coordinates of the selected flaw relative to the geometric information.

25. The method of claim 23 wherein the recommended sizing calculator is based on the size of a specific contour value.

26. The method of claim 25 wherein the defect contours are intensity contours, and wherein the intensity contours are based on amplitudes of the echo responses.

27. The method of claim 26 wherein the specific contour value corresponds to a −6 dB intensity drop from a maximum intensity contour.

28. The method of claim 23 wherein the recommended sizing calculator is based on a tip diffraction sizing method.
